(19) United States
(12) Patent Application Publication
(10) Pub. No.: US 2019/0219670 A1
(43) Pub. Date: Jul. 18, 2019

(54) Unambiguous Interferometer Radar Architecture

(71) Applicant: SRC, Inc., North Syracuse, NY (US)

(72) Inventors: Daniel R. Culkin, Woodbine, MD (US); Daniel T. Brown, Camden, NY (US); Harvey K. Schuman, Fayetteville, NY (US)

(73) Assignee: SRC, Inc., North Syracuse, NY (US)

(21) Appl. No.: 16/209,469

(22) Filed: Dec. 4, 2018

Related U.S. Application Data
(60) Provisional application No. 62/594,732, filed on Dec. 5, 2017.

(51) Int. Cl. G01S 7/28; H01Q 21/00; H01Q 21/06; G01S 13/68

(52) U.S. Cl. CPC G01S 7/2813; G01S 13/68; H01Q 21/061; H01Q 21/0025

(57) ABSTRACT

A transmit-receive radar system having multiple sub-apertures aligned in an offset, off-centered cross pattern that allows for searching of a sub-aperture pattern for the peak response without having to retransmit beams. The placement of the physical apertures combined with the use of MIMO operations provides a non-uniform distribution of virtual sub-apertures that suppresses ambiguous grading lobes and maintains angle resolution in a manner equivalent to that of non-MIMO approaches. As a result, target detection is enabled within a significantly larger angular area than in a non-MIMO configuration.

### CROSS-REFERENCE TO RELATED APPLICATIONS

The present application claims priority to U.S. Provisional Application No. 62/594,732, filed on Dec. 5, 2017.

### BACKGROUND OF THE INVENTION

### 1. Field of the Invention

The present invention relates to radar systems and, more particularly, to an active radiofrequency (RF) sensor composed of a sparse array of sub-apertures.

### 2. Description of the Related Art

Conventional interferometry approaches include sparse array, high angle resolution RF sensors used by the astronomy community, but these systems are receive only. A typical MIMO system produces a continuous, virtual array of two-way (transmit-receive) phase centers with only one transmit array and several receive arrays (or vice versa). These systems can produce very low side-lobe two-way patterns, however, the receive arrays are not widely separated and thus provide inferior angle estimation.

### BRIEF SUMMARY OF THE INVENTION

The present invention is a transmit-receive radar system that includes the ability to search a sub-aperture pattern for the peak response without having to retransmit beams. More specifically, the radar system includes an antenna having a plurality of sub-apertures that are aligned in an offset and off-centered pattern, wherein the antenna is configured to transmit and receive separate waveforms from each aperture, wherein each waveform has the same center frequency and bandwidth. The radar system also includes a digital signal processor coupled to the antenna and programmed to decode each of the separate waveforms received from each of the plurality of sub-apertures to provide a single dwell instantaneous angular estimation of a target location. Each waveform may be coded to be separable from each other waveform when received. The antenna may be configured so that each waveform will be received by each sub-aperture to provide a plurality of independent data streams equal to the number of plurality of sub-apertures squared. The digital signal processor may be programmed to construct a virtual antenna have a plurality of virtual sub-apertures. The plurality of sub-apertures and plurality of virtual sub-apertures may exhibit multiple pairings between the plurality of sub-apertures used to transmit each waveform and the plurality of sub-apertures and the plurality of virtual sub-apertures used to receive each waveform. The pattern of the plurality of sub-apertures is configured so that the plurality of sub-apertures and the plurality of virtual sub-apertures results in unambiguous target position estimation for any target within a beamspace of the antenna. The pattern of the plurality of sub-apertures may be configured to provide multiple distances between the plurality of sub-apertures. Phase difference may be performed simultaneously on the received waveforms to resolve target position with minimal ambiguity and maximum accuracy. The plurality of sub-apertures are aligned in a cross pattern.

The present invention also comprises a method of tracking a target that begins with transmitting a plurality of separate waveforms from an antenna having a corresponding plurality of sub-apertures aligned in an offset and off-centered pattern, wherein each waveform has the same center frequency and bandwidth. Next, the plurality of separate waveforms are received from the antenna using the corresponding plurality of sub-apertures aligned in an offset and off-centered pattern. Then, each of the separate waveforms received from each of the plurality of sub-apertures are decoded using a digital signal processor coupled to the antenna to provide a single dwell instantaneous angular estimation of a location of the target. Each waveform may be coded to be separable from each other waveform when received. Each waveform received by each sub-aperture provides a plurality of independent data streams equal to the number of plurality of sub-apertures squared. The digital signal processor may construct a virtual antenna have a plurality of virtual sub-apertures so that the plurality of sub-apertures and plurality of virtual sub-apertures exhibit multiple pairings with the plurality of sub-apertures used to transmit each waveform. The pattern of the plurality of sub-apertures may result in unambiguous target position estimation for any target within a beamspace of the antenna. The pattern of the plurality of sub-apertures may provide multiple distances between the plurality of sub-apertures. Phase difference may be performed simultaneously on the received waveforms to resolve target position with minimal ambiguity and maximum accuracy. The plurality of sub-apertures may be aligned in a cross pattern.

The maximum angle accuracy advantage of the MIMO array radar over the corresponding conventional non-MIMO array radar occurs in radar “search mode” or “target acquisition mode.” For these modes the conventional array radar transmits multiple beams to cover the volume subtended by the subarray pattern main lobe. The dwell of each beam is correspondingly reduced to maintain a needed measurement rate. This dwell reduction reduces the signal-to-noise ratio (SNR) per beam to about the same level as that of the associated MIMO radar that only need transmit one broad beam (of subarray pattern beamwidth) for the entire dwell to form the multiple beams. This equivalence in SNR coupled with the fact that the conventional radar applies the physical receive array in estimating angles whereas the MIMO radar applies the virtual array which is nearly twice as large as the physical array is the reason the MIMO radar provides nearly twice the angle accuracy with respect to the MIMO radar.

The placement of physical apertures combined with the use of MIMO operation creates a non-uniform distribution of virtual sub-apertures. This arrangement suppresses ambiguous grading lobes and maintains angle resolution in a manner equivalent to that of non-MIMO approaches while enabling target detection within a significantly larger angular area than in a non-MIMO configuration.

The present invention leverages interferometer style antenna configurations, with a plethora of antenna phase centers, such that each antenna phase center transmits a separable waveform that is received on all subaperture receive phase centers (either sequentially or simultaneously). The layout of the combined measurement of signals returned from one or more targets by both the physical and the virtual antenna paths enables an unambiguous determination of target position. The precision of the present invention is consistent with the maximum dimension enabled by the virtual antenna baseline and within a volume defined by the illuminated volume of the individual subaperture transmit patterns.

The approach of the present invention utilizes multiple transmit phase centers as well as multiple receive phase centers, referred to as multi-input multi-output (MIMO). MIMO uses N transmit phase center locations that are separable on receive in order to fully leverage each bidirectional path length available to the N apertures. For a given interferometer physical baseline, this approach reduces system angular measurement error by almost a factor of two when all improvements are taken into account. Stated another way, the use of MIMO will achieve as good or better accuracy than a conventional interferometer system that has a physical aperture of almost twice the dimension. In addition, the MIMO operation of this invention enables the detection of targets with maximum precision over a broader angular volume simultaneously than a non-MIMO configuration.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of antenna sub-apertures locations in a MIMO interferometer antenna according to the present invention;

FIG. 2 is a schematic of physical and virtual antennas in a MIMO interferometer antenna system according to the present invention;

FIG. 3 is a block diagram of a radar system employing a MIMO interferometer antenna according to the present invention;

FIG. 4 is a graph of a MIMO gain pattern in a MIMO interferometer antenna system according to the present invention;

FIG. 5 is a graph of the impact of receiver noise on angle estimation in an exemplary MIMO interferometer antenna system according to the present invention;

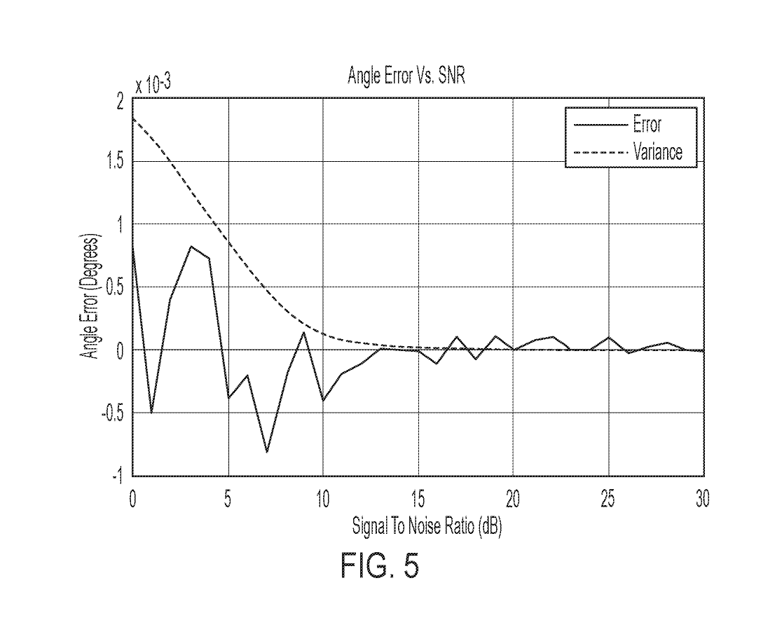

FIG. 6 is a graph of the multipath induced angle error in an exemplary MIMO interferometer antenna system according to the present invention; and

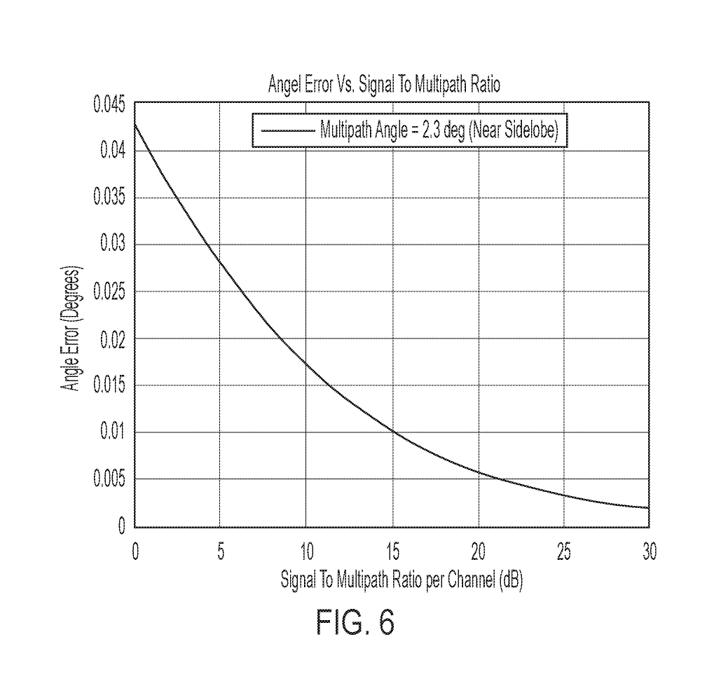

FIG. 7 is a graph of the impact of positional errors in an exemplary MIMO interferometer antenna system according to the present invention.

### DETAILED DESCRIPTION OF THE INVENTION

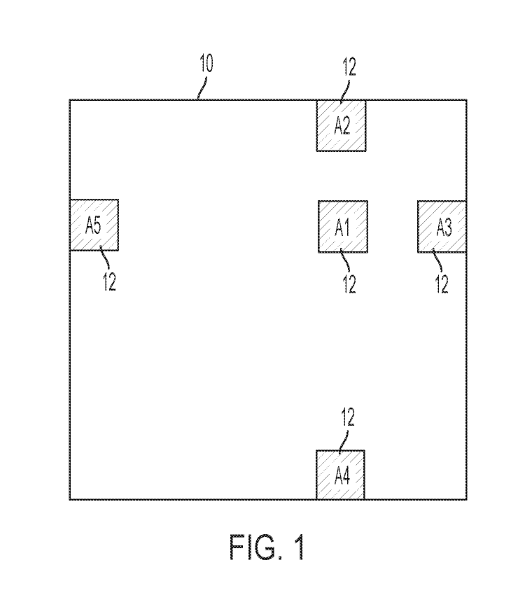

Referring to the figures, wherein like numeral refer to like parts throughout, there is seen in FIG. 1 an exemplary MIMO interferometer antenna system 10 having five sub-apertures 12, aligned in an offset, off-centered cross pattern according to the present invention to resolve targets within the entire sub-aperture beamspace, and to do so unambiguously. A separate waveform may be transmitted from each sub-aperture 12 simultaneously. Thus, system 10 of FIG. 1 assumes N separate waveforms are transmitted from each sub-aperture (or “aperture”), where N is the number of antenna sub-apertures 12. The waveforms are all of the same center frequency and bandwidth, and are coded such that they are separable (orthogonal) on receive. For example, the separability may be achieved via constant amplitude, phase coded waveforms, frequency coding, time sequencing, or other approaches, with each having varying benefits and challenges known in the art such that the approach can be selected as desired for a particular implementation.

The N separate transmit waveforms (transmitted from the N antenna physical phase centers) are received by each of the N apertures 12, providing N\hat{ }2 independent data streams. For example, a digital signal processor (DSP) may be programmed to perform the received waveform decoding for each of the five waveforms from each of the five sub-apertures, providing 25 total data streams. Each data stream represents the target being illuminated with and then reflecting back radar energy with a slightly different geometry and background noise contribution. Taking advantage of the plethora of geometries for the purpose of precision target angle estimation is what provides the accuracy advantage of the invention when compared to a conventional interferometer.

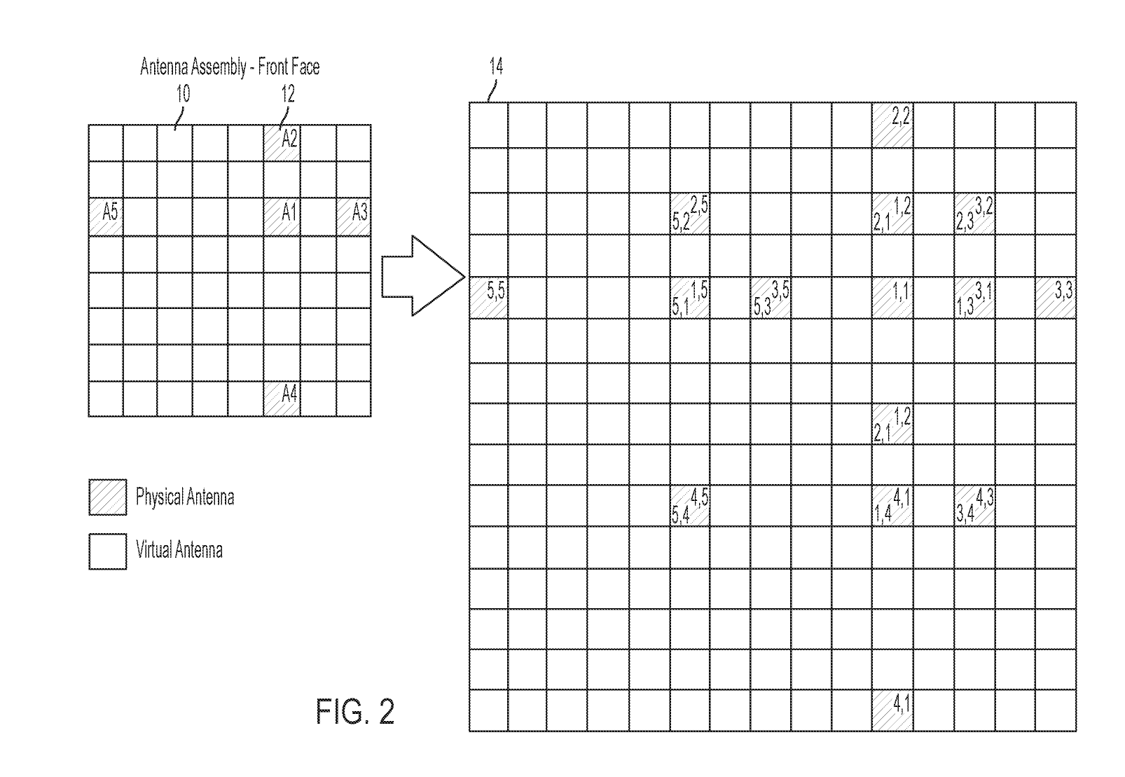

Visualization of the effect of the geometries that are made available through the MIMO interferometer implementation may be performed through a mathematical construction of a virtual antenna. An exemplary physical and combined physical and virtual aperture layout 14 associated with MIMO interferometer antenna system 10, i.e., the five subaperture 12 configuration seen in FIG. 1, is illustrated in FIG. 2. The numbering convention of the real and virtual apertures is y,x where y is the number of the receive aperture paired with the transmit aperture of number x. Note that most apertures of this example exhibit multiple pairings. It should be recognized that FIG. 2 is merely an example, and other patterns may be used in accordance with the present invention to include varied spacing between the apertures. A key aspect of the present invention involves target positional ambiguity resolution. The physical aperture layout can be accomplished such that the combination physical and virtual layout results in the availability of unambiguous target position estimation for any targets located within the beamspace of the individual physical antennas.

The placement of physical apertures combined with the use of MIMO operation creates a non-uniform distribution of virtual sub-apertures. This arrangement suppresses ambiguous grading lobes and maintains angle resolution in a manner equivalent to that of non-MIMO approaches while enabling target detection within a significantly larger angular area than in a non-MIMO configuration. The present invention leverages interferometer style antenna configurations, with a plethora of antenna phase centers, such that each antenna phase center transmits a separable waveform that is received on all subaperture receive phase centers (either sequentially or simultaneously). The layout of the combined measurement of signals returned from one or more targets by both the physical and the virtual antenna paths enables an unambiguous determination of target position. The precision of the present invention is consistent with the maximum dimension enabled by the virtual antenna baseline and within a volume defined by the illuminated volume of the individual subaperture transmit patterns.

The approach of the present invention utilizes multiple transmit phase centers as well as multiple receive phase centers, referred to as multi-input multi-output (MIMO). MIMO uses N transmit phase center locations that are separable on receive in order to fully leverage each bidirectional path length available to the N apertures. For a given interferometer physical baseline, this approach reduces system angular measurement error by almost a factor of two when all improvements are taken into account. Stated another way, the use of MIMO will achieve as good or better accuracy than a conventional interferometer system that has a physical aperture of almost twice the dimension. In addition, the MIMO operation of this invention enables the detection of targets with maximum precision over a broader angular volume simultaneously than a non-MIMO configuration

In a conventional interferometer, target estimation is made by phase comparison of the target return in multiple antenna apertures that are oriented to provide angular position. The larger the distance between apertures, the more accurate the target estimation. This approach, however, increases the number of ambiguous target positions (i.e., target positions that correspond to the same phase measurements). This effect can be somewhat mitigated through numerous techniques that require additional apertures at non-uniform spacing, or pre-existing knowledge of sufficient precision to resolve the target estimation into a single ambiguity area, or through target tracking methods that numerically eliminate unlikely ambiguity measurements. In the present invention, the data streams associated with the physical and virtual apertures are selected to provide multiple distances between apertures (both physical and virtual), resulting in different phase differences between apertures. The phase differences are present from apertures that are very close together (for example, apertures 1,1 and 3,1 (or 1,3) in FIG. 2), resulting in minimal ambiguity and minimal accuracy, through increasingly distant apertures that are progressively further apart to the maximum dimension (for example, apertures 5,5 and 3,3 in FIG. 2), resulting in maximum ambiguity and maximum accuracy. With the MIMO implementation and architecture of the present invention, the consideration of phase difference may be performed simultaneously such that the target position can be resolved with both minimal ambiguity and with maximum accuracy. Although a conventional non-MIMO sparse array system can, in principle, exhibit the same accuracy as that of the present invention, such a system would require retransmitting many times to form beams that cover the subaperture pattern. With the present invention, only one transmission period is required. The search beams are formed on receive using all two-way phase centers. The end result is an ability to simultaneously track multiple targets within the individual sub-aperture pattern volume with improved precision and accuracy.

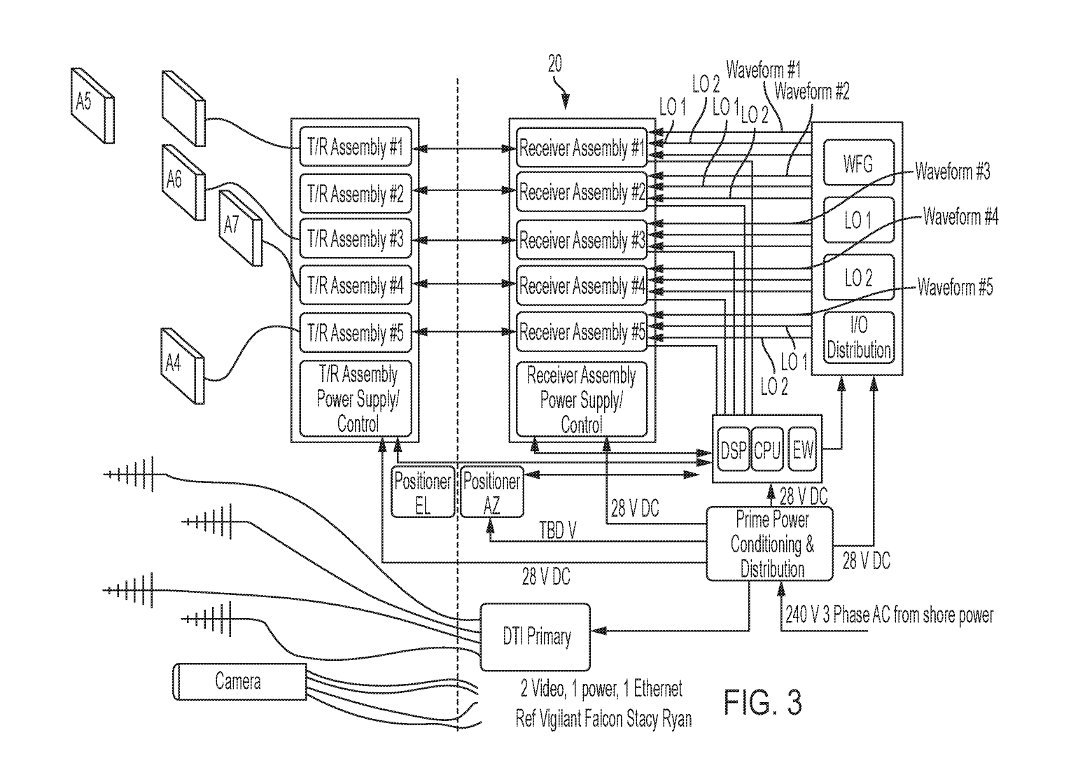

Referring to FIG. 3, an exemplary radar system 20 that includes a MIMO interferometer antenna system 10 having five antenna sub-apertures along with a processor and a system orientation subsystem. The five identical sub-apertures will perform both transmit and receive functions, and a total antenna dimension of 1.5 m may be assumed (edge to edge of the sub-apertures). The sub-apertures may be 7.5″ square and configured for fixed beam position operation with approximately 30 dB sidelobe levels. The individual sub-aperture gain may be approximately 28 dBi to yield an individual beamwidth of approximately 6.4°. A solid state transmitter may be utilized, providing a peak power of 100 W per aperture, and an available duty cycle of >10%. On receive, low-noise amplification is utilized, with appropriate switches, limiters, and other mechanisms to protect receiver components. The radar system 20 may operate across the Ku band with center frequency span of 16.0 GHz to 16.5 GHz, and then will typically utilize an instantaneous bandwidth of 40 MHz The radar system 20 may use a pulsed-Doppler operation schema, with digital beamforming occurring after each sub-aperture is independently digitized.

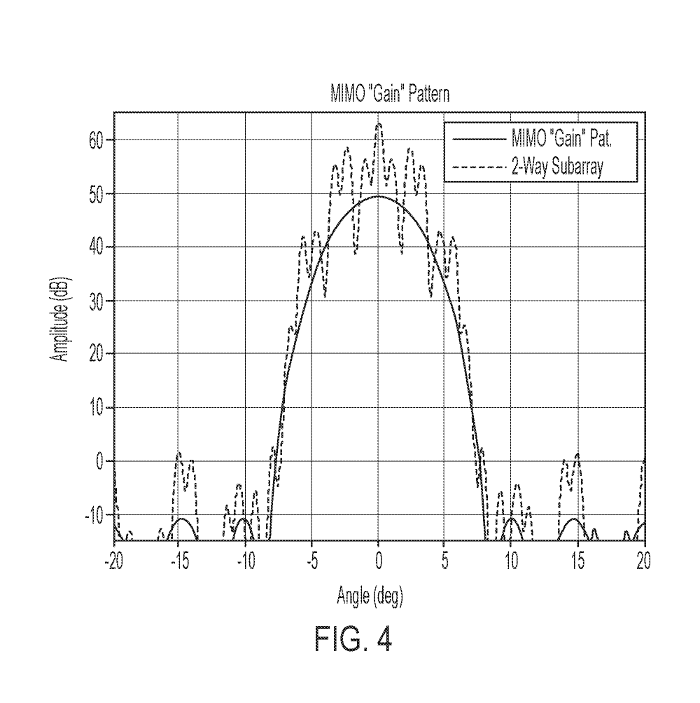

With respect to radar accuracy of the example system, system 10 was evaluated with a rectangular window of about a beamwidth that was centered at a true target direction of 0 degrees. The likelihood was computed over the window and the angle of peak response noted. This angle corresponds to the maximum likelihood angle estimate. The two-way antenna pattern with linear Taylor weighted subarrays is scaled to MIMO “Gain,” implying that it is normalized to the two-way sub-aperture array factor gain times the number of two-way phase centers (25 in the exemplary case). The two-way sub-aperture gain pattern is plotted in FIG. 4, and results from a 10 wavelength square aperture with 30 dB linear Taylor sidelobe weighting in elevation and azimuth and on both transmit and receive. The high sidelobes within the two-way sub-aperture pattern are evident, as expected, due to the sparseness of the MIMO array.

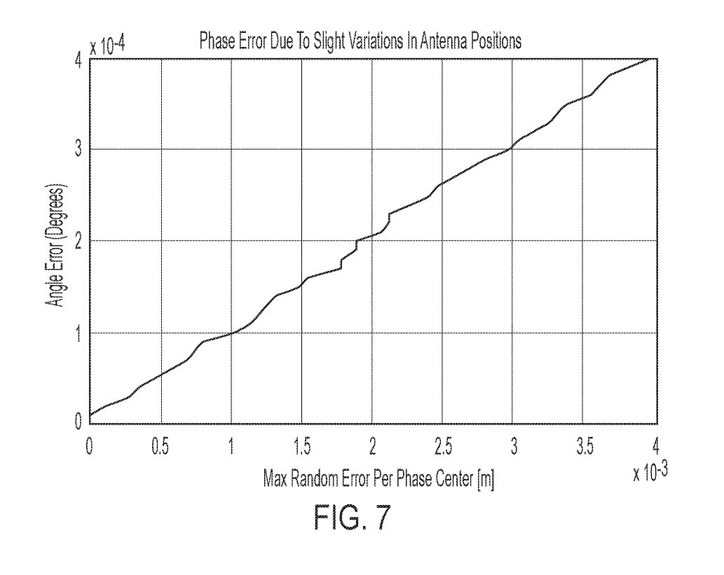

The effects of noise on the system were simulated by estimating the angle of arrival of a broadside (0 degree) target corrupted by receiver noise. The error (bias) and variance of the computed target angle with respect to truth versus signal-to-noise ratio (SNR) are shown in FIG. 7. The number of realizations was limited to 10,000. The bias might be expected to eventually converge to zero for a broadside target for all SNR. At SNR=25 dB, the angle error variance is well below ten thousandth of a degree.

The effect of multipath on angle estimation was determined for a broadside target and a multipath at 2.3° (near a high sidelobe). FIG. 8 shows the error as a function of signal to multipath amplitude ratio (SMR). From FIG. 4, the relative gain for multipath and direct path is only about −3 dB. Further, the small grazing angle multipath reflection coefficient may only be about −3 dB. From FIG. 9, the resulting 6 dB SMR implies over 0.025° of angle error.

The impact on angle estimation of small random positional errors of the sub-apertures with respect to each other was studied with a target that was broadside. The positional errors were modeled as random, uniformly distributed, independent out-of-plane displacements of the two-way sub-aperture phase centers. FIG. 9 shows the angle error as a function of peak displacement with the curve having an average of 10 realizations. Up to 4 mm of random positional error results in under 1 thousandth of a degree angle error.

As described above, the present invention may be a system, a method, and/or a computer program associated therewith and is described herein with reference to flowcharts and block diagrams of methods and systems. The flowchart and block diagrams illustrate the architecture, functionality, and operation of possible implementations of systems, methods, and computer programs of the present invention. It should be understood that each block of the flowcharts and block diagrams can be implemented by computer readable program instructions in software, firmware, or dedicated analog or digital circuits. These computer readable program instructions may be implemented on the processor of a general purpose computer, a special purpose computer, or other programmable data processing apparatus to produce a machine that implements a part or all of any of the blocks in the flowcharts and block diagrams. Each block in the flowchart or block diagrams may represent a module, segment, or portion of instructions, which comprises one or more executable instructions for implementing the specified logical functions. It should also be noted that each block of the block diagrams and flowchart illustrations, or combinations of blocks in the block diagrams and flowcharts, can be implemented by special purpose hardware-based systems that perform the specified functions or acts or carry out combinations of special purpose hardware and computer instructions.

What is claimed is:

1. A radar system, comprising:
an antenna having a plurality of sub-apertures that are aligned in an offset and off-centered pattern, wherein the antenna is configured to transmit and receive separate waveforms from each aperture, wherein each waveform has a center frequency and a bandwidth that is the same that is the same as each other waveform; and
a digital signal processor coupled to the antenna and programmed to decode each of the separate waveforms received from each of the plurality of sub-apertures to provide a single dwell instantaneous angular estimation of a target location.

2. The radar system of claim 1, wherein each waveform is coded to be separable from each other waveform when received.

3. The radar system of claim 2, wherein the antenna is configured so that each waveform will be received by each sub-aperture to provide a plurality of independent data streams equal to a number of plurality of sub-apertures squared.

4. The radar system of claim 3, wherein the digital signal processor is programmed to construct a virtual antenna have a plurality of virtual sub-apertures.

5. The radar system of claim 4, wherein the plurality of sub-apertures and plurality of virtual sub-apertures exhibit multiple pairings between the plurality of sub-apertures used to transmit each waveform and the plurality of sub-apertures and the plurality of virtual sub-apertures used to receive each waveform.

6. The radar system of claim 5, wherein the off-centered pattern of the plurality of sub-apertures is configured so that the plurality of sub-apertures and the plurality of virtual sub-apertures results in unambiguous target position estimation for any target within a beamspace of the antenna.

7. The radar system of claim 6, wherein the pattern of the plurality of sub-apertures is configured to provide multiple distances between the plurality of sub-apertures.

8. The radar system of claim 7, wherein phase difference is performed simultaneously on received waveforms to resolve target position with minimal ambiguity and maximum accuracy.

9. The radar system of claim 8, wherein the plurality of sub-apertures are aligned in a cross pattern.

10. A method of tracking a target, comprising the steps of:
transmitting a plurality of separate waveforms from an antenna having a corresponding plurality of sub-apertures aligned in an offset and off-centered pattern, wherein each waveform has a center frequency and a bandwidth that is the same as each other waveform; and
receiving the plurality of separate waveforms from the antenna using the corresponding plurality of sub-apertures aligned in an offset and off-centered pattern;
decoding each of the separate waveforms received from each of the plurality of sub-apertures using a digital signal processor coupled to the antenna to provide a single dwell instantaneous angular estimation of a location of the target.

11. The method of claim 10, wherein each waveform is coded to be separable from each other waveform when received.

12. The method of claim 11, wherein each waveform received by each sub-aperture provides a plurality of independent data streams equal to the number of plurality of sub-apertures squared.

13. The method of claim 12, wherein the digital signal processor constructs a virtual antenna have a plurality of virtual sub-apertures.

14. The method of claim 13, wherein the plurality of sub-apertures and plurality of virtual sub-apertures exhibit multiple pairings with the plurality of sub-apertures used to transmit each waveform.

15. The method of claim 14, wherein the pattern of the plurality of sub-apertures results in unambiguous target position estimation for any target within a beamspace of the antenna.

16. The method of claim 15, wherein the pattern of the plurality of sub-apertures provides multiple distances between the plurality of sub-apertures.

17. The method of claim 16, wherein phase difference is performed simultaneously on the received waveforms to resolve target position with minimal ambiguity and maximum accuracy.

18. The method of claim 17, wherein the plurality of sub-apertures are aligned in a cross pattern.
